(19) United States
(12) Patent Application Publication
(10) Pub. No.: US 2012/0189447 A1
(43) Pub. Date: Jul. 26, 2012

(54) INFRARED RADIATION DEVICE, PARTICULARLY INFRARED RADIANT HEATING DEVICE HAVING AN INFRARED HEATER

(75) Inventors: Sven Linow, Darmstadt (DE); Michael Tittmann, Hanau (DE)

(73) Assignee: HERAEUS NOBLELIGHT GMBH, Hanau (DE)

(21) Appl. No.: 13/499,519

(22) PCT Filed: Sep. 15, 2010
(86) PCT No.: PCT/EP10/05671

§ 371 Date: Mar. 30, 2012

(30) Foreign Application Priority Data
Oct. 2, 2009 (DE) 10 2009 048 081.1

(51) Int. Cl. F03D 11/00; H05B 1/00

(52) U.S. Cl. 416/95; 392/407

(57) ABSTRACT

An infrared device is provided, in particular an infrared radiation heating device having an infrared radiator for the heating of devices exposed to weather. The infrared device includes an emitter, wherein the emitter for radiating the infrared radiation is inserted in a housing, and the emitter is protected on the emitting side by a protection unit for the emitted radiation. The infrared radiator, the inner housing wall, and the unit are arranged such that cooling takes place by natural convection. A method is also provided for operating such a device in a wind turbine.

### CROSS-REFERENCE TO RELATED APPLICATIONS

This application is a Section 371 of International Application No. PCT/EP2010/005671, filed Sep. 15, 2010, which was published in the German language on Apr. 7, 2011, under International Publication No. WO 2011/038837 A2 and the disclosure of which is incorporated herein by reference.

### BACKGROUND OF THE INVENTION

The invention relates to an infrared radiation device, particularly an infrared radiation heating device having an infrared radiator for the heating of devices exposed to weather.

The essential prerequisite for the safe operation of a wind turbine is the exact measurement of the wind speed and the wind direction under all weather conditions. If the current wind speed and the current wind direction cannot be determined reliably, the wind turbine must be immediately transitioned to its rest position, in order to prevent damage to the turbine and to the surroundings. Shutting down the wind turbine unnecessarily results in immediate financial losses for the operator. To meet the necessary requirements (as also formulated in industrial standards) on the accuracy of the wind speed measurement, only cup-type anemometers have proven effective up until now, as described, for example, in R. S. Hunter et al. [eds]: Recommended Practices for Wind Turbine Testing: 11. Wind speed measurement and use of cup anemometry, International Energy Agency, 1. Ed. (1999).

One condition, which is especially critical for wind turbine, is icing under appropriate weather conditions. First, icing of the rotors leads to changes in mass and is thus associated with additional forces; these changes also result in reduced effectiveness in the conversion of wind energy into electrical energy. At the same time, the increased air density at low temperatures leads to an increased force effect. Second, there is the risk of freezing the anemometer for measuring the wind speed, as well as for the wind vane for measuring the wind direction.

The formation of frost on the anemometer, as well as the change in viscosity of the lubricants in the bearings, is also critical for wind turbines as described, for example, in: H. Seifert, “Eiszeit am Standort [Ice Age on Location],” DEWI Magazine, 26:68-75 (2005).; as well as S. Kimura et al., “Aerodynamic characteristics of an iced cup-shaped body,” Cold Regions Science and Technology, 33:45-58 (2001). In many weather conditions, the second effect can be avoided with so-called shaft heating. The first effect can be prevented with cup heating, as offered in some commercially available anemometers.

Because wind turbines are being used increasingly in environments at risk of icing, such as in Eastern Europe and Northern Europe or in areas with hills or mountains, and because the weather extremes in Europe are becoming larger—at the same time, significantly higher average wind speeds are appearing in Europe in Winter than in Summer—it is becoming increasingly more important that anemometers are ice-free at all times, even under extreme conditions. Under consideration of the structural properties of the materials in a wind turbine, the lower temperature limit is to be set at approximately −30° C.; this is currently set as the lower operating temperature down to which the safety of the turbine must still be ensured. As studies show, however, cup-heated and shaft-heated anemometers already start icing at higher typical wind speeds and a temperature of −10° C. In addition, the icing of structures surrounding the anemometers very strongly influences the accuracy of the wind measurements (T. Laakso et al., State-of-the-art of wind energy in cold climates, p. 13, International Energy Agency (2003)). These structures include lightning protection systems, which are mounted close to the anemometer on the nacelle, and also the lower area of the shaft, whose icing is especially critical, if vertical wind components can occur.

For these reasons, at locations that are heavily or frequently affected by icing it is useful, as an alternative or complementary to shaft and cup heating, to use an infrared radiation heating device, which heats and dries the anemometer and the shaft, as well as the surrounding devices.

The use of heating lamps according to DIN EN 60240-1 is known herewith. Such heating lamps are otherwise used, e.g., in pig breeding. These lamps, however, do not satisfy the mechanical requirements and also the requirements of reliability, so that they frequently must be replaced. In particular, pieces of ice detaching from the rotor blades immediately lead to lamp failure. At the same time, the use of tubular bulbs made of conventional glass limits the output power and large components of the radiation are reabsorbed by the tubular bulb and lost as convective heat.

The requirements on a technical solution for the infrared heating of the anemometer and wind vane, as well as the surrounding components, are given directly from the environmental conditions, the applied loads, the required service life, and the required power output. The heating system must function at all times under extreme temperatures, strong winds, the resulting strong structural loads, and in the event of humidity and moisture. Pieces of ice that could detach from the rotor blades and fall onto the infrared heating device represent a significant risk.

### BRIEF SUMMARY OF THE INVENTION

An object of the invention is thus to provide a device for infrared heating, wherein this device should exert the smallest possible effect on the air flow, and the flow of its wake should normally not affect the anemometer. At the same time, it must be able to irradiate as much as possible all surfaces of the anemometer.

The infrared radiation heating device according to the invention for the heating of devices exposed to weather, particularly anemometers for measuring wind speed, for use for wind turbines, as well as wind vanes and lightning protection systems, comprises an emitter for emitting the infrared radiation, which is inserted in a housing, and the emitter is protected on the emitting side by a unit that is essentially transparent for the emitted radiation.

Provided that the infrared radiator, the inner housing wall, and the protective unit are adapted to each other, only cooling by natural convection is required. Therefore, a device is provided that already has all of the required properties for use in extremely difficult environmental conditions. Extreme operational reliability with very high mechanical stability is achieved only through reduction to the minimum required functions. At the same time, the use of a protective unit allows the safe installation of one (or more) infrared radiators that must be optimized not only with regard to break safety—although its tubular bulb is made of break-proof quartz glass—but is also optimized with regard to efficiency of the heating of the components to be heated, the direction of emission, and unavoidable waste heat. This is realized by the shape of the tubular bulb, the emitted spectrum, the ratio of tubular bulb surface to emitted output power, and other measures, which are explained in the dependent claims.

Advantageously, the protective unit is a glass pane made of quartz glass. Quartz glass is extremely weather resistant compared with typical glasses, has high mechanical strength, and has an advantageously high degree of transmission far into the infrared, so that the infrared radiation of the heating emitters does not unnecessarily heat up the heating device, but instead provides heating for the anemometer and surrounding elements.

It has been shown that there is a positive effect if the protective unit is a glass pane made of thermally or chemically pre-stressed glass. Here, in particular, aluminosilicate glasses having different properties are conceivable. Pre-stressed glass or panes of safety glass have a significantly increased fracture strength compared with normal glass. In order to have satisfactory transmission in the infrared, however, the use of, e.g., aluminosilicate glass is to be preferred compared with soda-lime glasses. In particular, the use of chemically pre-stressed aluminosilicate glass (e.g., Corning Glass 2317) has proven effective.

In one advantageous embodiment, the invention provides that the protective unit has a lattice made of heat-resistant metal. In particular, in devices that emit very high output powers, so that the glasses named above could become overheated, or in devices that emit downwardly, the use of a lattice made of heat-resistant stainless steel instead of glass panes has proven effective. In devices that are exposed to extreme loads, e.g., due to a particularly large number of days with icing of the rotor blades, a combination of suitable glass and a lattice made of heat-resistant stainless steel has proven effective.

It is further advantageous if the radiation emitted primarily from the heating element of the infrared radiator is absorbed less than 20% by the protective unit, especially preferred less than 10% by the protective unit. The lower the energy absorption in the protective device is, the higher the efficiency in the heating device and the smaller the disadvantages due to strong heating of the protective device. It must be prevented that the protective glasses—especially those that are not made of quartz glass—are heated so much that the mechanical properties are changed. For single-pane safety glass, this is already the case in the vicinity of the lower annealing point.

Here, the emission wavelength of the radiator, the absorption properties of the glass, the expected contamination of the glass, and the surface distribution of a protective lattice must be matched to each other.

One advantageous embodiment of the invention provides that the inner housing wall is constructed as an infrared reflector. Here it is achieved that, first, a high efficiency of the device is achieved and, second, a strong heating or overheating of the unit is prevented. The infrared reflectors are to be made of heat-resistant, break-proof material, so that stainless steel or even better hot dip aluminized steel can be used that remains stabile up to approximately 400° C.

It has been shown that it is advantageous if the inner housing wall is constructed as a functional reflector and here projects the radiation emitted by the infrared radiator particularly onto the components to be irradiated. “Functional” means that the emission is directed by the geometry of the reflector in a suitable way onto the components to be heated. For this purpose, e.g., parabolic shapes can be used. The goal is to optimize the system, e.g., by use of suitable software with regard to homogeneous illumination (even for the loss of one unit, if several are used).

In one advantageous embodiment, the invention provides that the envelope tube of the infrared radiator is coated with a heat-resistant reflector made of an opaque oxide. Different than coatings of lamp bulbs with metallic layers, a non-alternating reflector layer can be achieved that has constant properties of emission over a long service life.

Here, it is advantageous if the oxide has nearly the same elemental composition as the material of the envelope tube with a deviation of less than 5% in composition. This has proven effective for simultaneously achieving especially good resistance of the layer, even with frequent and large temperature changes and for achieving optimal reflectivity of the layer in the infrared.

It has been shown that the object according to the invention can be realized in an especially good way with at least three heating devices, wherein the object could also be achieved with two functioning units. If three (or more) heating devices arranged symmetrically around the element to be irradiated are used (which could also be located in a common housing), then the influence of asymmetrically arranged components is minimized (asymmetry could lead to an undesirably reinforced directional dependency of the measurement result of the anemometer). At the same time, the properties of the heating devices can also be tuned to the geometry of the element to be heated, so that functioning is still ensured even with the loss of one heating device.

It has furthermore been shown that it is advantageous if a shaft heating device or a cup heating device is used at the same time. This further increases the redundancy and thus the operating reliability of the measuring device.

The device is here constructed such that the heating output power can be regulated. In particular, if several heating elements are provided, then these can be activated as a function of the actual weather conditions. While for moderate wind speeds and relatively high temperatures down to approximately −10° C., one shaft heating device is still adequate, it has been shown that, especially either in the event of strong winds and at extremely low temperatures or in the event of rain, the use of infrared heating devices additionally or by themselves is to be preferred.

### DETAILED DESCRIPTION OF THE INVENTION

The invention will be explained in more detail below with reference to several preferred embodiments.

### Embodiment 1

Infrared radiation heating device for a cup anemometer with integrated wind vane and lightning protection system.

The heating device is mounted on the lightning protection system and heats the anemometer with its cups from above. The anemometer cups are made of metal and coated with a heat-resistant, water-repellant coating, preferably absorbing IR radiation in the range from 1000 nm to 3000 nm (a black enamel). The anemometer also has a shaft heating device. The heating device consists of an outer, impact-resistant housing made of metal. Three short-wave infrared radiators having a filament temperature of 2200° C. are mounted in this housing. The infrared radiators are coated with a reflector made of opaque quartz glass on their side facing away from the anemometer. The infrared radiators here each irradiate almost the entire surface area of the anemometer, each with 250 W output power. Therefore, the loss of one radiator can be adequately compensated. An inner reflector made of bare stainless steel is arranged enveloping the radiators. For protecting the radiators, underneath this there is a lattice of 1.0 mm thick wire made of heat-resistant stainless steel (e.g., 1.4404), wherein the wire mesh assumes less than 20% of the surface area in front of the radiators. Through offset openings in the inner reflector sheet, as well as in the outer sleeve, a sufficient cooling of the entire unit is achieved by natural convection independent of the wind speed.

The unit is mounted 25 cm above the anemometer and has an outwardly round and aerodynamic shape, so that it influences the wind speed on the anemometer only in the event of greatly falling or increasing winds. Comparison measurements between a free-standing anemometer and the anemometer mounted with the heating device show an effect on the anemometer results only in the event of winds having vertical components >30%.

### Embodiment 2

Infrared radiation heating device for a cup anemometer with integrated wind vane and lightning protection system.

Here, three heating elements are arranged symmetrically below the plane of the anemometer and mounted on the three lightning protection system rods joined to an enveloping cage. These heating elements irradiate the anemometer, the wind vane, and opposing rods of the lightning protection system. Each of the three units has an outer envelope made of metal with ventilation slots, an inner metallic reflector having offset ventilation slots, which deflect stray radiation from the infrared radiators in the direction of the components to be irradiated, an infrared radiator having a short-wave emitting coil made of tungsten, which is operated in nominal operation at 2000° C. and is thus designed for a maximum service life. A break-proof glass pane made of 4 mm thick quartz glass is mounted in front of the unit, wherein less than 5% of the power output from the filament is absorbed by this pane. Due to the arrangement of the ventilation slots, natural convection allows sufficient cooling of the entire unit, even in the event of almost static air.

Due to the arrangement and the power output of 300 W for each unit, with additional shaft heating, the function of the anemometer can be maintained for medium wind speeds and temperatures down to approximately −20° C., even in the event of the loss of one unit. Due to the arrangement of the elements approximately 20 cm below the plane of the anemometer, the anemometer measurement is affected by wake turbulence of the heating units only starting approximately at rising winds having a vertical component of >25%.

### Embodiment 3

Infrared radiation heating device for a cup anemometer with integrated wind vane and lightning protection system.

Here, three heating elements are arranged symmetrically below the plane of the anemometer and mounted on the three lightning protection system rods joined to an enveloping cage. These thereby irradiate the anemometer, the wind vane, and opposing rods of the lightning protection system. Each of the three units has an outer envelope made of metal with ventilation slots, an inner metallic reflector having offset ventilation slots, which deflect stray radiation from the infrared radiators in the direction of the components to be irradiated, an infrared radiator having a medium-wave emitting coil made of an alloy of chromium, iron, and aluminum, which is operated in nominal operation at 1000° C. and is thus designed for a maximum service life. A break-proof glass pane made of 4 mm thick quartz glass is mounted in front of the unit, wherein less than 20% of the power output from the filament is absorbed by this pane. The arrangement of the ventilation slots allows sufficient cooling of the entire unit through natural convection, even in the event of almost static air.

Due to the arrangement and the output power of 250 W for each unit, with additional shaft heating, the function of the anemometer can be maintained for medium wind speeds and temperatures down to approximately −15° C., even in the event of the loss of one unit. Due to the arrangement of the elements approximately 10 cm below the plane of the anemometer, the anemometer measurement is affected by wake turbulence starting approximately for rising winds having a vertical component of >20%.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-13. (canceled)

14. An infrared radiation heating device, comprising an infrared radiator, an emitter for emitting infrared radiation, a housing in which the emitter is located, and an essentially transparent protection unit for the emitted radiation which protects the emitter on an emitting side, wherein the infrared radiator, an inner housing wall, and the protection unit are arranged to be cooled by natural convection.

15. The device according to claim 14, wherein the protection unit comprises a glass pane made of quartz glass.

16. The device according to claim 14, wherein the protection unit comprises a glass pane made of thermally and/or chemically pre-stressed glass.

17. The device according to claim 14, wherein the protection unit comprises a lattice made of heat-resistant metal.

18. The device according to claim 14, wherein radiation emitted by a heating element of the infrared radiator is absorbed less than 20% by the protection unit.

19. The device according to claim 14, wherein radiation emitted by a heating element of the infrared radiator is absorbed less than 10% by the protection unit.

20. The device according to claim 14, wherein an inner housing wall is constructed as an infrared reflector.

21. The device according to claim 14, wherein an inner housing wall is constructed as a functional reflector.

22. The device according to claim 14, wherein the infrared radiator has an envelope tube with a heat-resistant reflector made of an opaque oxide.

23. The device according to claim 22, wherein the oxide essentially corresponds to an elemental composition of an envelope tube material of the device with a deviation of less than 5% in composition.

24. The device according to claim 14, wherein heating output of the infrared radiator can be regulated.

25. The device according to claim 14, wherein the infrared radiator heats devices exposed to weather.

26. A wind turbine including a heating device according to claim 14.

27. A wind turbine including at least two heating devices according to claim 14.

28. A wind turbine including at least three heating devices according to claim 14.

29. A wind turbine including a heating device according to claim 14 and a shaft heating device and/or a cup heating device.
